(19) United States
(12) Patent Application Publication
(10) Pub. No.: US 2010/0244366 A1
(43) Pub. Date: Sep. 30, 2010

(54) METHOD OF CONTROLLING THE FORCE OF A SOLENOID, A CONTROLLABLE FORCE TRANSDUCER AND THE USE THEREOF

(76) Inventor: Jörgen Sundmark, Katrineholm (SE)

Correspondence Address: DICKSTEIN SHAPIRO LLP, 1825 EYE STREET NW, Washington, DC, 20006-5403, US

(21) Appl. No.: 12/095,706

(22) PCT Filed: Nov. 30, 2006
(86) PCT No.: PCT/SE06/01372

§ 371 Date: May 30, 2008

(30) Foreign Application Priority Data
Dec. 1, 2005 (SE) 0502630-7

(51) Int. Cl. B65H 3/06; H02K 41/035

(52) U.S. Cl. 271/109; 318/3

(57) ABSTRACT

A method of controlling a solenoid for controlling the force thereof, and a controllable force transducer includes that only a small part of the maximal stroke length of the solenoid is utilized, whereby the exerted force thereof is substantially constant within said stroke-length distance, when the solenoid is fed with a constant driving power. At a constant driving voltage, the feed current can be controlled for a proportional alteration of the exerted force of the solenoid within said stroke-length distance. The controller finds favourable use in a sheet separator.

The invention relates to a method and a controllable force transducer of the kind that is seen in the preamble of the appended independent claim and the arrangement claim, respectively, and the use of such a force transducer.

In equipment manufacturing, there is frequently desires about and needs for an electrically driven component that at substantially constant driving conditions, for instance a constant driving power, can present a substantially constant driving force along a driving distance, and that moreover easily can be controlled in order to exert another driving force, and that furthermore commands a low price.

Therefore, an object of the invention is to provide a method and a controllable solenoid by means of which said desires can be met entirely or partly. An additional object is to provide a favourable use of such a technique for a sheet separator.

The object is entirely or partly attained by the invention.

The invention is defined in the appended independent claims.

Embodiments of the invention are defined in the dependent claims.

In one embodiment, a sheet separator may comprise two independently rotatable rolls or rollers abutting against each other.

One of the separator rollers rotates in the same rotational direction as the driver roller. Therefore, the mentioned first separator roller and the driver roller may be driven by a common driving motor and be mutually coupled by a fixed transmission. The second separator roller is preferably arranged rotatable in an opposite direction to the first separator roller. A group of sheets fed in toward the entry nip between the separator rollers is, in that connection, oriented so that the end sheet comes closest to the first separator roller and the group of the other sheets accordingly comes closest to the second separator roller, and is thereby diverted by the same on the entry side of the nip. By the fact that the group of sheets has a low speed at the entrance of the separator nip, and furthermore the second separator roller has the indicated rotation, the sheets conveyed by the end sheet are diverted on the entry side of the separator nip and can be diverted in order to be taken care of in a manner known per se.

In order for the separator to have a proper separation function, it is required that the surface of the first roller has a higher friction coefficient than the surface of the second roller, and furthermore, it is naturally required that the abutment pressure between the separator rollers can be maintained within narrow limits in spite of wear.

Known constructions to maintain an adjustable contact force between the rollers in that connection, in spite of wear, commands a high price. For that sake, a special displacement arrangement is utilized for this purpose for pressing one of the separator rollers by an easily controllable force, which is substantially independent of the wear of the separator rollers and the diameter change following thereby.

This arrangement may be formed of a solenoid comprising a magnet winding and a core displaceable thereby. A person skilled in the art knows that such a solenoid produces a driving force that varies considerably with the applied current at a given driving voltage, along the maximal displacement path of the solenoid. However, by guaranteeing that only a small portion of the maximal distance of motion of the solenoid is made use of for the mutual parallel displacement of the separator rollers, the state is attained that upon constant voltage, the force exerted by the solenoid becomes substantially linearly dependent on the applied current. Accordingly, one of the movable separator rollers may be driven against the second separator roller by a force that is easily controllable and insensitive to changes in the efficient stroke length of the solenoid (the wear of the separator rollers).

In the following, the invention will be described by way of examples, reference being made to the appended drawing.

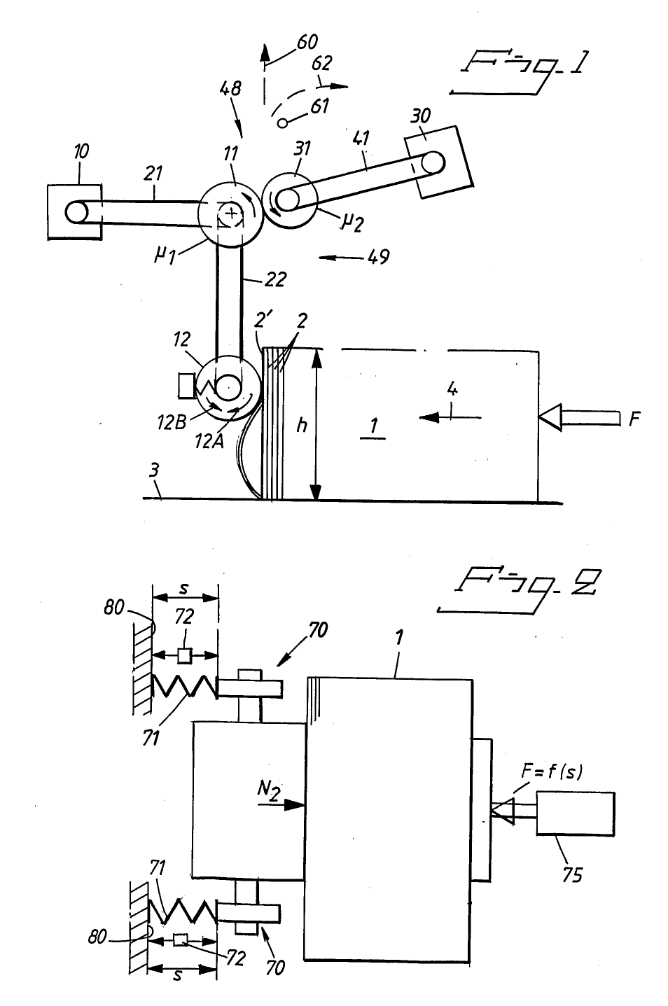

FIG. 1 schematically shows a side view of an outfeed arrangement and a separator for sheets from a sheaf of sheets.

FIG. 2 schematically shows an arrangement in order to control the abutment force of the outfeed arrangement against the sheaf of sheets.

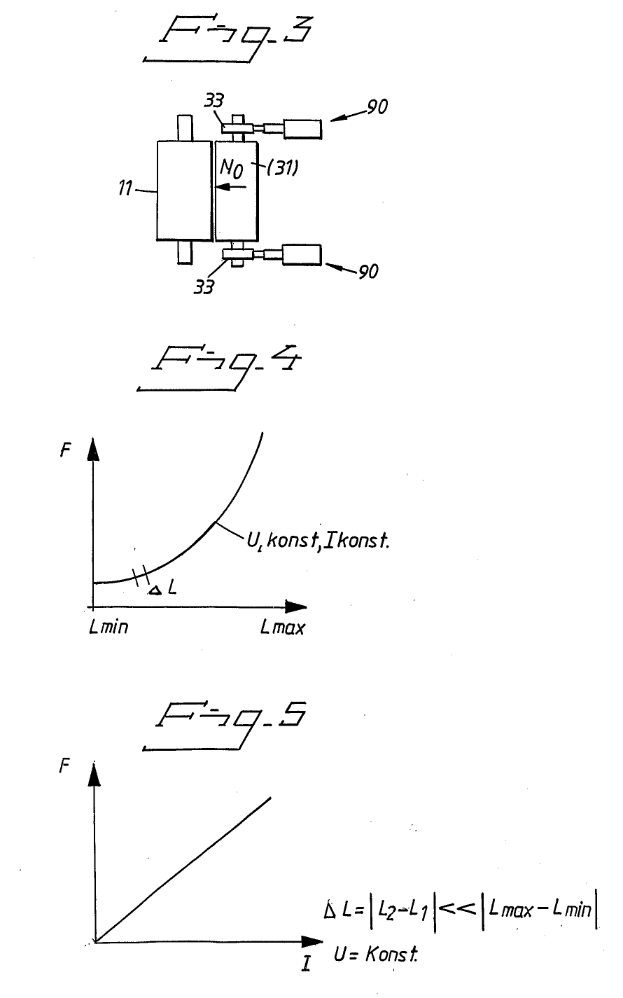

FIG. 3 schematically shows an arrangement for the control of the abutment force between two rollers of the separator.

FIG. 4 schematically shows the variation of the force exerted by a solenoid over the entire stroke-length range thereof, at a constant driving voltage and driving current.

FIG. 5 shows the relation between the force and feed current of the solenoid within a small part range of the stroke length of the solenoid.

In FIG. 1, a substratum 3 is shown, on which a stack of sheets 1 rests. The stack of sheets 1 comprises sheets stacked on each other such as, for instance, banknotes, which normally have an identical format and usually have the extension plane thereof perpendicular to the substratum surface 3, which is parallel to the adjacent side surface of the stack. The stack 1 is displaced in the longitudinal direction 4 thereof so that the end sheet 2′ thereof is pressed against an outfeed roller 12, which is parallel to the substratum and to the sheets 2, and contacts the stack 1 at a height above the substratum 3 that preferably is in the upper half thereof, i.e., at a distance in the range of 0.4-0.9 h above the substratum 3.

The stack 1 is pressed against the roller 12 by a force N₂, which in combination with the friction coefficient of the circumference surface of the roller 12 produces a selected displacement force of the end sheet 2 upon the rotation of the roller 12.

The stack of sheets 1 may be displaced in relation to the roller 2 together with the substratum 3. Alternatively, the stack 1 may be displaced along the substratum 3. The substratum 3 is provided at least in the area below the end sheet 2′. In FIG. 1, furthermore a separator 48 is seen, which is arranged to receive and lead through the end sheet 2 when the same is fed upward in the plane thereof. If the end sheet 2′ is accompanied by one or more adjacent sheets 2 from the stack, the separator serves to separate and divert the accompanying sheets and divert them by a diversion arrangement 49 (not shown in detail), so that only a single sheet, the end sheet 2′, passes the separating arrangement and is further led to a conveyor 60. A sensor 61 may be arranged beyond the separator 48 and detect passed banknotes, for instance in order to detect a banknote 2′ possibly accompanying the end banknote 2′, so that in such a case the passing group of banknotes 2, 2′ can be diverted by a diversion arrangement 61 in a known way per se.

The separator 48 is shown to comprise two cylindrical rollers 11, 31 being mutually parallel and pressed against each other. A motor 10 is shown to rotationally drive the separator roller 11 via a belt transmission 21, and the outfeed roller 12 via another transmission 22. The second separator roller 31 is rotationally driven from a motor 31 via a transmission 41, and the roller 31 is rotatable independently of the rotation of the roller 11.

When feeding out the end sheet 2′ from the stack 1, the roller 12 is first rotated in a first rotational direction 12A so that the end sheet 2′ is driven toward the substratum 3 and in that connection experiences an elastic bulged shape between the substratum 3 and the contact point between the roller 12 and the stack 1. In that connection, the conveying distance of the sheet 2′ is small in order to guarantee that the bulging of the sheet 2′ is elastic and that the bulged sheet 2′ still is in engagement with the roller 12. Next, the rotation of the roller 12 is reversed so that the roller rotates in the rotational direction 12B, whereby the end sheet 2′ is displaced upward, away from the substratum 3 toward an entrance nip between the separator rollers 11, 31. If the end sheet 2′ is accompanied by one or more adjacent sheets in the movement thereof toward the separator, said accompanying sheets 2 can be separated from the end sheet 2′, provided that the group of sheets enters the separator 48 at a low speed. By rotating the roller 31 in a direction such that the circumference surface thereof runs reverse the circumference surface of the roller 11, a separation effect is attained for the accompanying sheets/banknotes 2. The envelope surface of the roller 11 has a friction coefficient μ₁ that is higher than the friction coefficient μ₂ of the roller 31, and the opposite rotational directions of the rollers 11 and 31 entail that the circumference surface of the roller 31 can affect the upper edges of the accompanying sheets 2 along a relatively long distance, so that an efficient separation process is attained compared with the roller 31 standing idle. The periphery speed of the roller 31 is usually lower than the periphery speed of the roller 11. An outfeed operation of a banknote 2′ is carried out within a period of time of a few milliseconds.

An efficient separation of sheets in a group of sheets that enters the separator 48 implies that the sheets enter the separator at a low speed, but the roller 12 has to feed out the sheet 2′ at a high speed from the stack 1 in order for a sheetoutfeed operation to be executable within a necessarily short period of time. Since the driving motor 10 of the roller 10 is arranged to quickly accelerate the roller 12 and then brake the roller 12, this function may in an advantageous manner be utilized by the fact that the acceleration and the retardation of the roller 12, and thereby of the sheet 2′ and possible accompanying sheets 2′, are repeated one or more times during the transportation of the sheet 2′ toward the separator 48. During each such subsequent acceleration of the end sheet 2′, the possibility of a separation of the end sheet 2′ from the nearby sheet 2 is improved.

The driving of the end sheet 2′ by the roller 12 in a controlled manner implies, among other things, that the abutment force of the roller 12 against the end sheet 2′ is maintained within narrow limits.

For that sake, it is suggested that the roller 12′ is arranged displaceable in the direction of motion 4 of the stack 1. A mounting 70 for the shaft shank of the roller 12 is carried from a support 80 via a spring 71 having a known spring characteristic. A sensor 72 detects the distance between the support 80 and the mounting 70. This distance s represents the support force against one end of the shaft shank. With the corresponding arrangements at both shaft ends, the normal force N₂ of the roller 12′ against the end sheet 2′ can be maintained by means of a pusher 75, which applies a force for which the sensors 72 detect a preselected distance s.

Since the rollers 11, 31 in the separator 48 will slide against each other or against sheets 2 situated between the same, they are subjected to wear, which means that the rollers 11, 31 have to be movable toward each other and be pressed by an external force transducer in order to have a predetermined mutual abutment force N₀ (FIG. 3).

In accordance with a further development of the invention, for that sake it is suggested that one of the separator rollers is arranged displaceable in parallel toward the other roller 11 in a common axis plane, the shaft journals of the roller 31 being received in corresponding displaceable mountings 33, which are displaced by a respective linear solenoid 90.

FIG. 4 illustrates that such commercially available solenoids 90 have a linear stroke length between a minimum value Lₘᵢₙ and a maximum value Lₘₐₓ. When a constant voltage U and a constant current I is applied to such a solenoid, the solenoid develops a varying force over the stroke-length range thereof. This makes that a plain solenoid has been considered less suitable for force control.

We have found that for such a solenoid, a small stroke-length range δ₁ may be selected, in which the force can be considered linear. In that connection, FIG. 5 illustrates that, at a constant driving voltage U, it is easy to control the generation of force of the solenoid 90 by a feed current I being proportional thereto. In this way, there are good prospects to maintain a total abutment pressure between the separator rollers and also to compensate for wear of the rollers 11, 31.

A particular advantage of using rollers 11, 31 that are pressed against each other is that, in the situation that a group of sheets 2′, 2 cannot be separated by the separator but remains on the entrance nip of the separator, this condition can be detected by, for instance, the sensor 49, which then provides for the withdrawal of the solenoids 90, so that the sheaf can pass through the separator, the sensor 61 situated downstream of the separator detecting that a plurality of sheets simultaneously pass the separator and, in that connection, instructing the diversion arrangement 62 to divert said group of sheets. The alternative would otherwise be that the assembly would need to be stopped, waiting for an operator to obviate the problem (to remove the sheaf abutting against the entry side of the separator 48).

The use of the solenoids 90 implies naturally that the wear of the rollers 11, 31 is relatively small, i.e., that the axial distance between the rollers 11, 31 is a short length much smaller than the maximal stroke length of the solenoids.

From the structure according to FIG. 1, it can be understood that the roller 12 may be directly driven from the motor 10 via the transmissions 21, 22 and that the roller 11 also may be directly driven by the motor 10, i.e., that no freewheels or the like are required. The same thing applies to the roller 31 and the direct driving thereof from the motor 30 via the transmission 41.

By rotating the roller 31 in an opposite direction to the roller 11, a prolonged sliding motion is attained between the envelope surface of the roller 31 and the end edges of the sheets in the group of sheets brought to the roller nip of the separator by the feed roller 12.

1. A method of controlling the force of a linear solenoid having a maximum stroke length, characterized in that the action distance of the solenoid is limited to a small part of the maximal stroke length thereof, whereby the solenoid, in one the action direction thereof, at a constant feed power, gives essentially a constant force within the limited action distance, and that the force within the limited action distance is proportionally controllable by the control of the feed power of the solenoid.

2. Method according to claim 1, characterized in that the feed voltage of the solenoid is kept constant and that the feed current of the solenoid is varied, the action force of the solenoid being substantially linearly dependent on the feed current.

3. Method according to claim 1 or 2, characterized in that the solenoid is used to mutually press a pair of mutually parallel and mutually movable rollers against each other within an axial distance range of the rollers, which corresponds to a mutually allowable periphery wear of the rollers, the axial distance variation being at most equal to said portion of the stroke length of the solenoid and the rollers belonging to a sheet separator.

4. Method according to claim 3, characterized in that the rollers are rotationally driven and have a mutually equal rotational direction, whereby the envelope surfaces thereof experience a wear upon abutment and mutual motion, the rollers forming a part of a separator for a group of sheets inserted into the roller nip.

5. A controllable force transducer comprising a linear solenoid having a predetermined maximum stroke length, characterized by means for limiting, in one action direction of the solenoid, the action distance of the solenoid to a small fraction of the maximal stroke length thereof, whereby the solenoid can exert a constant force in said one action direction for a constant feed power, and whereby the action force of the solenoid within the action distance is proportionally controllable by the control of the feed power.

6. Controllable force transducer according to claim 5, characterized by means for controlling the feed current of the solenoid at a constant feed voltage, the feed current being proportional to the exerted force of the solenoid.

7. A use of a controllable force transducer according to claim 5 or 6 for mutual pressing of a pair of mutually movable and rotatable rollers included in a sheet separator, by a constant force against each other within an axial distance range corresponding to an allowable mutual roller wear.
